(19) United States
(12) Patent Application Publication
(10) Pub. No.: US 2024/0211895 A1
(43) Pub. Date: Jun. 27, 2024

(54) MAINTENANCE SCHEDULING DEVICE AND MAINTENANCE SCHEDULING METHOD

(71) Applicant: FANUC CORPORATION, Minamitsuru-gun, Yamanashi (JP)

(72) Inventor: Shuxiao XIE, Yamanashi (JP)

(21) Appl. No.: 18/288,434

(22) PCT Filed: Jun. 4, 2021
(86) PCT No.: PCT/JP2021/021448

§ 371 Date: Oct. 26, 2023

(51) Int. Cl. G06Q 10/1093; G06Q 10/20

(52) U.S. Cl. CPC G06Q 10/1097; G06Q 10/20

(57) ABSTRACT

When performing maintenance of a machine pertaining to required maintenance items for a robot, a machine tool, and a peripheral apparatus, etc., periodic component replacement work and inspection work of another machine is automatically added and an optimal maintenance schedule is established. The present invention is a maintenance scheduling device that: acquires a work time period pertaining to additional work required for inspection other than the maintenance pertaining to the required maintenance items; and when the additional work can be implemented within a remaining work time period obtained by subtracting the work time period for maintenance pertaining to the required maintenance items from the entire work time period set for the maintenance day, establishes a maintenance schedule to which the additional work is added.

### TECHNICAL FIELD

The present invention relates to a maintenance scheduling device and a maintenance scheduling method.

### BACKGROUND ART

For machines such as robots, machine tools, and peripheral equipment (also referred to below as “industrial machines” or “producing machines”) that make up a production system, for example, a maintenance schedule is formulated by a system/facility manager, who is a knowledgeable person with expertise and experience, based on operating conditions of the machines. In this regard, for example, a known industrial robot checkup timing notification device notifies a maintenance request when post-checkup cumulative operating time, which is the cumulative actual operating time since the last checkup, exceeds a predetermined value (also referred to as “checkup interval period”) for each component of an industrial robot (for example, Patent Document 1). Similarly, a known control device serves as a peripheral equipment checkup timing notification device and notifies a maintenance request when post-checkup cumulative operating time, which is the cumulative operating time since the last checkup, exceeds a predetermined value (checkup interval period) for peripheral equipment by measuring, as the operating time, periods of time during which control signals are outputted to the peripheral equipment or periods of time during which peripheral equipment actuating signals are outputted (for example, Patent Document 2). A known numerical control device determines, for example, the next checkup interval period for each component of a machine tool based on the amount of change in state quantities (for example, voltage, insulation resistance value, deformation amount, vibration frequency, and usage time corresponding to checkup items of each component of the machine tool) since the last checkup, and notifies the next checkup date and time (for example, Patent Document 3).

Another known control device predicts when a failure of a component of a machine is likely to occur based on machine operating information and automatically orders the component, thereby notifying when the component of the machine can be replaced (for example, Patent Document 4).
Patent Document 1: Japanese Unexamined Patent Application, Publication No. S58-223594
Patent Document 2: Japanese Patent No. 5956627
Patent Document 3: Japanese Unexamined Patent Application, Publication No. 2014-174680
Patent Document 4: Japanese Unexamined Patent Application, Publication No. 2017-102554

### DISCLOSURE OF THE INVENTION

### Problems to be Solved by the Invention

Machines such as robots, machine tools, and peripheral equipment are producer goods, which are subjected to maintenance operations for either or both of predetermined mandatory maintenance items and mandatory maintenance items required due to, for example, a malfunction or a warning of a predicted malfunction. A system/facility manager therefore needs to create a maintenance schedule that allows for such mandatory maintenance item-related maintenance on each machine by setting a suitable and acceptable maintenance date (shutdown date). When maintenance for mandatory maintenance items is scheduled to be performed on a machine, for example, it is desirable to formulate an optimized maintenance schedule by additionally scheduling, for example, periodic component replacement operations and checkup operations for other machines in excess time available during the mandatory maintenance. However, it is difficult for the system/facility manager to grasp all information related to periodic component replacement operations and checkup operations for each producing machine, and it is difficult to formulate an optimal maintenance schedule by additionally scheduling periodic component replacement operations and checkup operations for other machines in excess time available on a scheduled maintenance date (shutdown date). When maintenance for mandatory maintenance items is scheduled to be performed on a machine among machines including robots, machine tools, and peripheral equipment, therefore, it is desirable to formulate an optimized maintenance schedule by automatically scheduling periodic component replacement operations and checkup operations for other machines on a scheduled maintenance date (shutdown date) in addition to the maintenance on the machine for the mandatory maintenance items.

An object of the present invention is to provide a maintenance scheduling device and a maintenance scheduling method for, when maintenance for mandatory maintenance items is scheduled to be performed on a machine among machines that make up a production system such as robots, machine tools, and peripheral equipment, formulating an optimized maintenance schedule by automatically scheduling a periodic component replacement operation and a checkup operation (referred to below as “operation necessary for failure prevention” or simply as “operation necessary for checkup”) for another machine on a scheduled maintenance date (shutdown date) in addition to the maintenance on the machine for the mandatory maintenance items.

### Means for Solving the Problems

(1) A maintenance scheduling device according to an aspect of the present invention includes:
a mandatory maintenance operation information acquisition unit configured to acquire mandatory maintenance items related to an industrial machine, a maintenance date on which maintenance for the mandatory maintenance items is performed, and an operation time required for the maintenance for the mandatory maintenance items;
a maintenance operation information acquisition unit configured to acquire maintenance operation information including at least checkup items related to industrial machines including a robot that are each expected to exceed a checkup interval period before or on the maintenance date and an operation time required for each of additional operations necessary for the checkup items;
an addition feasibility determination unit configured to determine whether or not each of the additional operations is executable within a remaining operation time calculated by subtracting the operation time required for the maintenance for the mandatory maintenance items from an overall operation time set for the maintenance date; and
a maintenance schedule formulation unit configured to formulate a maintenance schedule that includes, in addition to the maintenance, every additional operation determined to be executable by the addition feasibility determination unit out of the additional operations.

(2) A maintenance scheduling method according to another aspect of the present invention includes implementation by a computer of:
a mandatory maintenance operation information acquisition step for acquiring mandatory maintenance items related to an industrial machine, a maintenance date on which maintenance for the mandatory maintenance items is performed, and an operation time required for the maintenance for the mandatory maintenance items;
a maintenance operation information acquisition step for acquiring maintenance operation information including at least checkup items related to industrial machines including a robot that are each expected to exceed a checkup interval period before or on the maintenance date and an operation time required for each of additional operations necessary for the checkup items;
an addition feasibility determination step for determining whether or not each of the additional operations is executable within a remaining operation time calculated by subtracting the operation time required for the maintenance for the mandatory maintenance items from an overall operation time set for the maintenance date; and
a maintenance schedule formulation step for formulating a maintenance schedule that includes, in addition to the maintenance, every additional operation determined to be executable in the addition feasibility determination step out of the additional operations.

### Effects of the Invention

According to the present invention, it is possible to provide a maintenance scheduling device and a maintenance scheduling method that make it possible to, when maintenance for mandatory maintenance items is scheduled to be performed on a machine among machines that make up a production system such as robots, machine tools, and peripheral equipment, formulate an optimized maintenance schedule by automatically scheduling a periodic component replacement operation and a checkup operation for another machine on a scheduled maintenance date (shutdown date) in addition to the maintenance on the machine for the mandatory maintenance items.

### BRIEF DESCRIPTION OF THE DRAWINGS

FIG. 1 is a diagram illustrating a schematic configuration of a production system;

FIG. 2 is a diagram illustrating a schematic configuration of each machine control device;

FIG. 3 is a diagram illustrating an example of a schematic configuration of a maintenance scheduling device;

FIG. 4 is a flowchart showing an overview of processing in the maintenance scheduling device;

FIG. 5A is a flowchart showing details of a determination process for determining whether or not each additional operation is executable, in the processing in the maintenance scheduling device; and

FIG. 5B is a flowchart showing details of a determination process for determining whether or not each additional operation is executable, in the processing in the maintenance scheduling device.

### PREFERRED MODE FOR CARRYING OUT THE INVENTION

The following describes an embodiment of the present invention with reference to the drawings. It should be noted that the embodiment is described by way of example and the technical scope of the present invention is not limited thereto.

### First Embodiment

### <Overall Configuration of Production System 100>

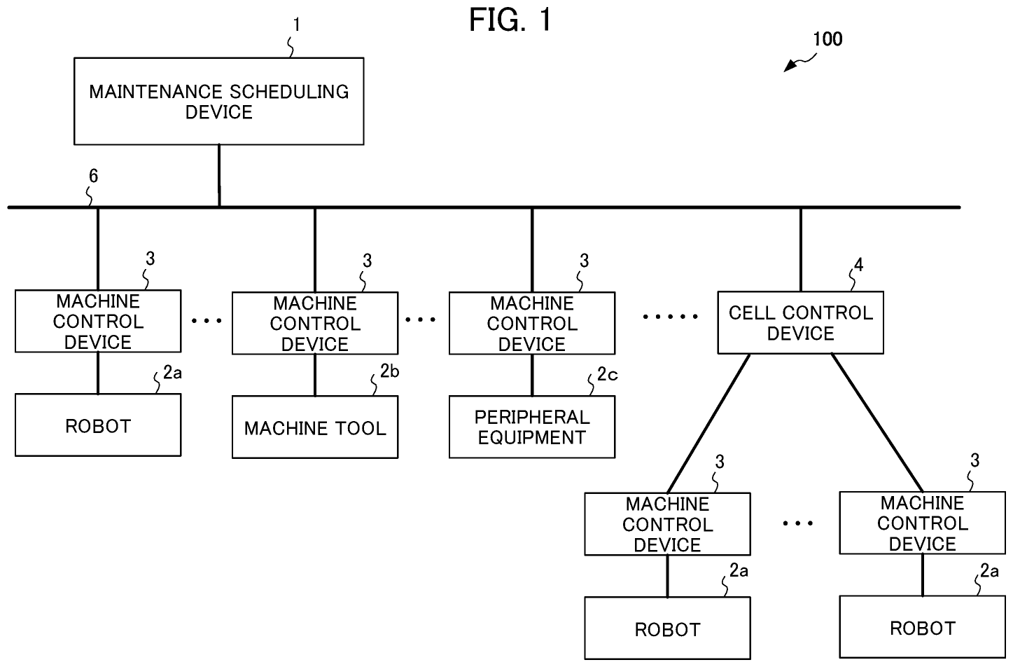

FIG. 1 is a diagram illustrating an example of a schematic configuration of a production system 100.

As illustrated in FIG. 1, the production system 100 includes, for example, industrial machines 2 such as a plurality of robots 2a, a machine tool 2b, and peripheral equipment 2c, machine control devices 3 that control the respective industrial machines 2, a maintenance scheduling device 1, and a communication network 6.

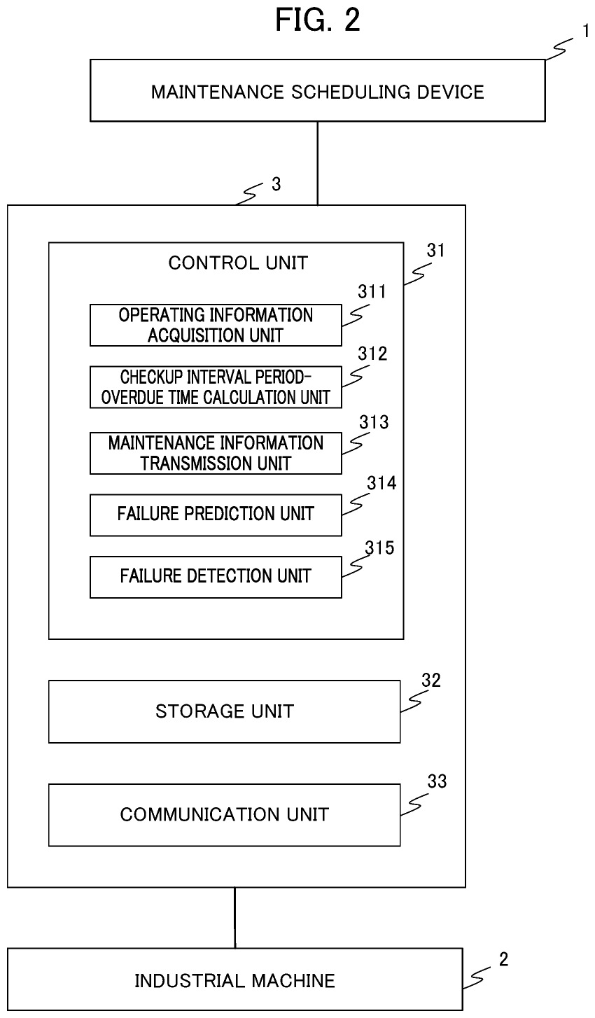

FIG. 2 is a diagram illustrating an example of a schematic configuration of each machine control device. Each machine control device 3 includes, for example, a control unit 31, a storage unit 32, and a communication unit 33, and is communicatively connected to the maintenance scheduling device 1 via the communication network 6. The storage unit 32 stores therein a pre-selected component of an industrial machine 2, such as a robot 2a, for which operating information is acquired by an operating information acquisition unit 311 described below. The storage unit 32 also stores therein operating information of the industrial machine 2 including the pre-selected component. The storage unit 32 may also store other information such as information on checkup items related to a checkup operation that is necessary for checkup of the pre-selected component and a maintenance time required for the checkup items. Specifically, the maintenance time required for the checkup items may be calculated, for example, by recording periods of time required for such maintenance (checkup) as historical information. The storage unit 32 may also contain, for example, a maintenance time required for a maintenance operation for maintenance items required due to, for example, a malfunction or a warning of a predicted malfunction. The storage unit 32 may also contain information on a maintenance operation for mandatory maintenance items. Examples of mandatory maintenance items include mandatory maintenance items required due to, for example, a malfunction or a warning of a predicted malfunction, maintenance and checkup items for a machine that has significantly exceeded its checkup interval period (that has exceeded a predetermined threshold), and maintenance items preset as mandatory.

In addition to a known function of controlling the behavior of the corresponding industrial machine 2, the control unit 31 includes the operating information acquisition unit 311, a checkup interval period-overdue time calculation unit 312, and a maintenance information transmission unit 313 as described below.

The operating information acquisition unit 311 stores operating information of the industrial machine 2 in the storage unit 32 at preset time intervals. Examples of operating information include variables that indicate the drive state, such as current value supplied to a drive motor, output of a rotational position detector attached to the drive motor, and output of a sensor attached to the industrial machine 2. Other examples of operating information include cumulative operating time, cumulative power consumption, input voltage/current, output voltage/current, environmental temperature, environmental humidity, vibration, cutting fluid usage, and cooling fan rotation number of the corresponding industrial machine 2. The cumulative operating time, the cumulative power consumption, the input voltage/current, the output voltage/current, the environmental temperature, the environmental humidity, the vibration, and other data may be acquired for each printed circuit board that forms the industrial machine 2.

The checkup interval period-overdue time calculation unit 312 calculates, if the corresponding industrial machine 2 is determined to have exceeded the checkup interval period of the pre-selected component, an overdue time (also referred to as “checkup interval period-overdue time”), which is the duration of time elapsed after the checkup interval period has passed, based on the checkup interval period of the component calculated based on the operating information acquired by the operating information acquisition unit 311. Specifically, if the cumulative operating time or the like since the last checkup has exceeded a preset threshold, the checkup interval period-overdue time calculation unit 312 calculates a cumulative operating time from the time of exceedance of the threshold to the present time as the checkup interval period-overdue time.

The maintenance information transmission unit 313 transmits, to the maintenance scheduling device 1 via the communication network 6, maintenance operation information of at least the industrial machine 2 such as a robot 2a determined to have exceeded the checkup interval period. Note here that the maintenance operation information includes the checkup interval period-overdue time related to the component of the industrial machine 2 such as a robot 2a. The maintenance operation information may also include an operation time required for a checkup operation for the component.

The control unit 31 may include a failure prediction unit 314 and a failure detection unit 315. The failure prediction unit 314 calculates failure prediction information that predicts, for example, when a failure of the component of the corresponding industrial machine 2 is likely to occur, based on the operating information acquired by the operating information acquisition unit 311. In the case of the failure prediction for an arm drive motor of a robot 2a as the industrial machine 2, for example, the failure prediction unit 314 can calculate the rate of increase in speed difference between a speed commanded based on a motion program and an actual speed calculated based on the rotation angle detected by the rotational position detector, and thus predict when the speed difference is likely to exceed a threshold, which is a boundary of a normal range thereof. It should be noted that as the maintenance time required for the machine for which a failure has been predicted, for example, the time required for the maintenance to address the failure may be recorded as historical information. A technique known to those skilled in the art such as disclosed in Patent Document 4 can be employed for the failure prediction, and therefore detailed description thereof is omitted. Similarly, the failure detection unit 315 can detect a failure by, for example, detecting an abnormal state based on the operating information acquired by the operating information acquisition unit 311.

The production system 100 may include a cell control device 4 including a plurality of industrial machines 2 and machine control devices 3 that control the respective industrial machines 2. As shown in FIG. 1, the cell control device 4 is, for example, communicatively connected to the machine control devices 3 that control the respective industrial machines 2 located in a single cell. Although not shown, the cell control device 4 may have functional units equivalent to the operating information acquisition unit 311, the checkup interval period-overdue time calculation unit 312, the maintenance information transmission unit 313, the failure prediction unit 314, and the failure detection unit 315 of each machine control device 3 included in the cell. Specifically, the cell control device 4 may acquire operating information from each machine control device 3 included in the cell, calculate the checkup interval period-overdue time in each machine control device 3 based on the operating information, and transmit maintenance operation information of at least an industrial machine 2 determined to have exceeded the checkup interval period to the maintenance scheduling device 1 via the communication network 6. Next, the maintenance scheduling device 1 will be described.

The maintenance scheduling device 1 according to the present embodiment is described using an example in which the industrial machines 2 are robots 2a. However, the present invention is not limited to being applied to the robots 2a. For example, the present invention is applicable to a production system 100 including other machines such as peripheral equipment 2c. The present invention is also applicable to a production system including a machine tool 2b and peripheral equipment 2c.

The maintenance scheduling device 1 is adapted to formulate an optimized maintenance schedule for the robots 2a forming the production system 100 by, for example, setting a suitable and acceptable maintenance date (shutdown date) for the aforementioned mandatory maintenance item-related maintenance on a machine and automatically scheduling, in addition to the mandatory maintenance item-related maintenance on the machine, a periodic component replacement operation and a checkup operation for another machine, thereby effectively utilizing a shutdown time on the maintenance date. The maintenance scheduling device 1 may be configured as a single computer or as a distributed processing system in which a plurality of computers are connected via a communication network, for example. Alternatively, the maintenance scheduling device 1 may be, for example, configured as a virtual server (virtual machine) that is set up on a cloud. Alternatively, the maintenance scheduling device 1 may be, for example, included in an edge device.

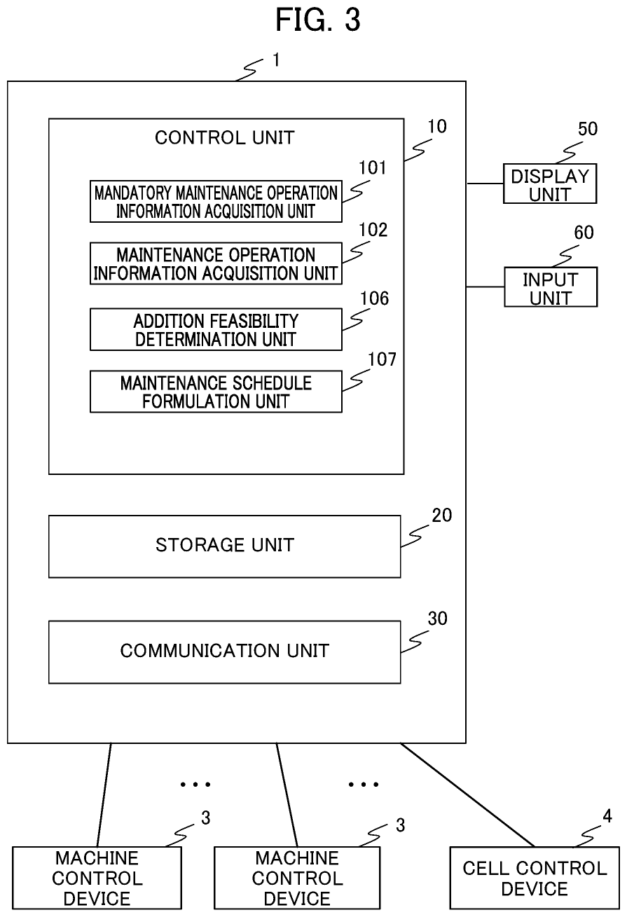

FIG. 3 is a diagram illustrating an example of a schematic configuration of the maintenance scheduling device 1. As illustrated in FIG. 3, the maintenance scheduling device 1 includes a control unit 10, a storage unit 20, a communication unit 30, a display unit 50, and an input unit 60. The control unit 10 is a central processing unit (CPU) that performs overall control of the maintenance scheduling device 1. The control unit 10 reads and executes an operating system (OS) and an application program stored in the storage unit 20 as appropriate, and thus cooperates with the hardware described above to implement various functions.

Specifically, the present embodiment is described using an example in which the maintenance scheduling device 1 is implemented through a computer executing a program. The program can be stored on a non-transitory computer readable information recording medium such as a compact disc, a flexible disk, a hard disk, a magneto-optical disk, a digital video disc, magnetic tape, read-only memory (ROM), electrically erasable programmable ROM (EEPROM), flash memory, or semiconductor memory.

The program can be written in a programming language for behavioral-level description of electronic circuits. In this case, various design diagrams, such as a wiring diagram and a timing chart of an electronic circuit are generated from the program described in the programming language for behavioral-level description of electronic circuits, and an electronic circuit that forms the maintenance scheduling device 1 described above can be created based on the design diagrams. For example, based on the program written in the programming language for behavioral-level description of electronic circuits, it is possible to configure the maintenance scheduling device on hardware that can be reprogrammed using field programmable gate array (FPGA) technology, and it is possible to configure a specialized electronic circuit tailored for a specific purpose using application specific integrated circuit (ASIC) technology.

Details of the control unit 10 are described below. The storage unit 20 is a storage area such as a hard disk or a semiconductor memory device for storing, for example, data and a program necessary for the control unit 10 to perform various processes. For example, a maintenance scheduling program is stored in the storage unit 20. The maintenance scheduling program is intended to implement functions of the control unit 10 described below.

The communication unit 30 is a communication interface for communication between the machine control devices 3 and the cell control device 4.

The display unit 50 includes, for example, a display device such as a liquid crystal display or an organic electroluminescent panel. The display unit 50 displays an image as per an instruction received from the control unit 10. The input unit 60 includes, for example, an input device (not shown) such as a physical switch referred to as a numeric keypad or a touch panel overlaid on a display surface of the display unit 50.

The following describes the control unit 10. As shown in FIG. 3, the control unit 10 reads and executes the operating system (OS) and the application program stored in the storage unit 20 as appropriate, and thus cooperates with the hardware, thereby configuring a mandatory maintenance operation information acquisition unit 101, a maintenance operation information acquisition unit 102, an addition feasibility determination unit 106, and a maintenance schedule formulation unit 107.

The mandatory maintenance operation information acquisition unit 101 can acquire the following information from the system/facility manager through the input unit 60: identification information of a robot 2a subject to a maintenance operation for mandatory maintenance items, the mandatory maintenance items, a maintenance operation time required for each mandatory maintenance item, a maintenance date, and an operation time set for the maintenance date. Examples of mandatory maintenance items include, but are not limited to, items of maintenance to address a malfunction or a predicted failure of an industrial machine 2, a checkup operation for an industrial machine that has significantly exceeded the checkup interval period, and preset periodic maintenance. The system/facility manager may set any mandatory maintenance items as desired. The mandatory maintenance operation information acquisition unit 101 may receive an identification number of the robot 2a subject to the maintenance operation for the mandatory maintenance items, the mandatory maintenance items, and the operation time required for the maintenance for the mandatory maintenance items from the machine control device 3 or the cell control device 4 via the communication network 6. Then, the system/facility manager can set a maintenance date and a group composed of one or more maintenance engineers needed to work simultaneously on the maintenance date. The group composed of one or more maintenance engineers needed to work simultaneously may be, for example, allowed to perform maintenance on robots 2a installed in the same area within the range of the operation time. The area where each robot 2a is installed can be managed in association with the identification number of each robot 2a. Thus, the identification numbers of the robots 2a can be used to easily determine whether or not different robots 2a are installed in the same area. It should be noted that the system/facility manager may set a different group of maintenance engineers for performing maintenance on each of robots 2a installed in different areas. Such setting for robots 2a installed in different areas helps to effectively utilize the shutdown time by automatically scheduling, in addition to the maintenance on a robot 2a for mandatory maintenance items, a periodic component replacement operation and a checkup operation for another robot 2a.

The maintenance operation information acquisition unit 102 acquires maintenance operation information from the machine control devices 3 and the cell control device 4 via the communication network 6. The maintenance operation information includes identification numbers of any robots 2a that are each expected to exceed the checkup interval period before or on the maintenance date acquired by the mandatory maintenance operation information acquisition unit 101, checkup items related to each of such robots 2a, and an operation time required for each of additional operations necessary for the checkup items, other than the information on the robot 2a set to be subject to the mandatory maintenance. In a case where the maintenance operation information acquisition unit 102 cannot acquire the operation time required for the additional operation necessary for the checkup items related to each of the robots 2a from the machine control devices 3 or the cell control device 4, the maintenance operation information acquisition unit 102 may acquire such information from the system/facility manager through the input unit 60.

The addition feasibility determination unit 106 determines whether or not each of the additional operations necessary for the checkup items related to the robots 2a that have exceeded the checkup interval period is executable within a remaining operation time calculated by subtracting the operation time required for the maintenance for the mandatory maintenance items from the overall operation time set for the maintenance date. Specifically, in a case where a group composed of one or more maintenance engineers needed to work simultaneously performs maintenance on a robot 2a installed in an area assigned to this group, the addition feasibility determination unit 106 determines whether or not an additional operation necessary for checkup items related to another robot 2a installed in this area and determined to have exceeded the checkup interval period is executable within a remaining operation time calculated by subtracting an operation time required for the maintenance on the robot 2a installed in this area for the mandatory maintenance items from the overall operation time set for the group of maintenance engineers as described above.

In a case where multiple robots 2a installed in the same area have exceeded their respective checkup interval periods, the addition feasibility determination unit 106 may set a priority ranking based on the checkup interval period-overdue time of each of such robots 2a. By doing so, the addition feasibility determination unit 106 can determine, in the order of the priority ranking, whether or not the additional operation necessary for the checkup items related to each of the robots 2a that have exceeded the checkup interval period is executable within the remaining operation time calculated by subtracting the operation time required for the maintenance on the robot 2a installed in this area for the mandatory maintenance items from the overall operation time. Upon determining that the additional operation is executable for a robot 2a, for example, the addition feasibility determination unit 106 can continue to determine whether or not the additional operation is executable for a robot 2a having the next highest priority using an updated remaining operation time calculated by subtracting the operation time required for the additional operation necessary for checkup of the robot 2a determined to be executable from the previously calculated remaining operation time. It should be noted that the addition feasibility determination unit 106 may terminate the determination once the additional operation is determined to be not executable for a robot 2a, and determine that the additional operation is not executable for all other of the robots 2a having a lower priority. The above-described form of the determination is referred to as a “first determination form”. The first determination form makes it possible to prioritize a robot 2a having a higher priority in scheduling the checkup of robots 2a that have exceeded the checkup interval period. The form of the determination that is made in the order of the priority ranking is not limited to the first determination form. According to the first determination form, the addition feasibility determination unit 106 makes the determination in the order of the priority ranking, and once the additional operation is determined to be not executable for a robot 2a, the addition feasibility determination unit 106 determines that the additional operation is not executable for all other of the robots 2a having a lower priority. However, the determination may be made as described below as another determination form (referred to as a “second determination form”.

According to the second determination form, the addition feasibility determination unit 106 determines whether or not each of the additional operations necessary for the checkup items related to the robots 2a that have exceeded the checkup interval period is executable in the order of the priority ranking described above. Upon determining that the additional operation is executable for a robot 2a, for example, the addition feasibility determination unit 106 continues to determine whether or not the additional operation is executable for a robot 2a having the next highest priority using an updated remaining operation time calculated by subtracting the operation time required for the additional operation necessary for checkup of the robot 2a determined to be executable from the previously calculated remaining operation time. It should be noted that upon determining that the additional operation is not executable for a robot 2a, the addition feasibility determination unit 106 continues to determine whether or not the additional operation is executable for a robot 2a having the next highest priority. By doing so, the addition feasibility determination unit 106 can determine whether or not the additional operation is executable for all other of the robots 2a having a lower priority. This form makes it possible to schedule checkup of more robots 2a that have exceeded the checkup interval period.

It should be noted that in the first and second determination forms, the addition feasibility determination unit 106 may set the priority ranking based on the checkup interval period-overdue time of each robot 2a by giving preference to a robot 2a having a longer overdue time. Alternatively, the addition feasibility determination unit 106 may set a different priority ranking by giving preference to a robot 2a having a greater ratio of the checkup interval period-overdue time relative to the checkup interval period of the robot 2a. Specifically, for example, a robot 2a having a larger value of Y/X may be given preference, where X is the length of the checkup interval period, Y is the length of the overdue time, and Y/X is the ratio of the overdue time Y to the checkup interval period X. By doing so, it is possible to make a relative comparison between a robot having a longer checkup interval period and a robot having a shorter checkup interval period based on the ratio of the checkup interval period-overdue time of each robot 2a to the checkup interval period thereof.

If the addition feasibility determination unit 106 determines that the additional operation necessary for checkup is executable within the operation time set for the maintenance date, the maintenance schedule formulation unit 107 formulates a maintenance schedule that includes the additional operation in addition to the maintenance for the mandatory maintenance items. The maintenance schedule formulation unit 107 can provide the thus formulated maintenance schedule to the system/facility manager through the display unit 50, for example. The configuration of each functional unit of the maintenance scheduling device 1 according to the present embodiment has been described above. Next, the flow of processing in the maintenance scheduling device 1 will be described.

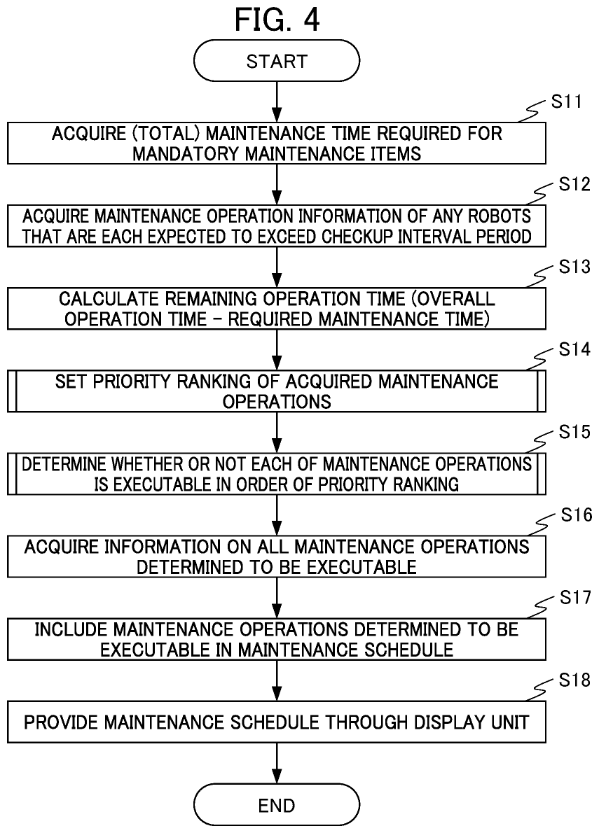

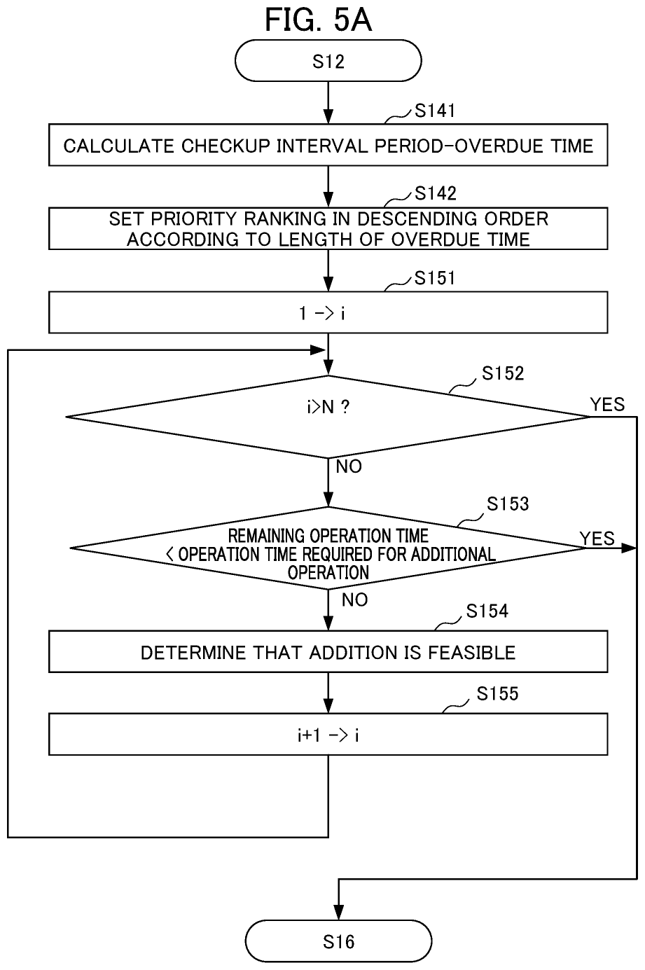

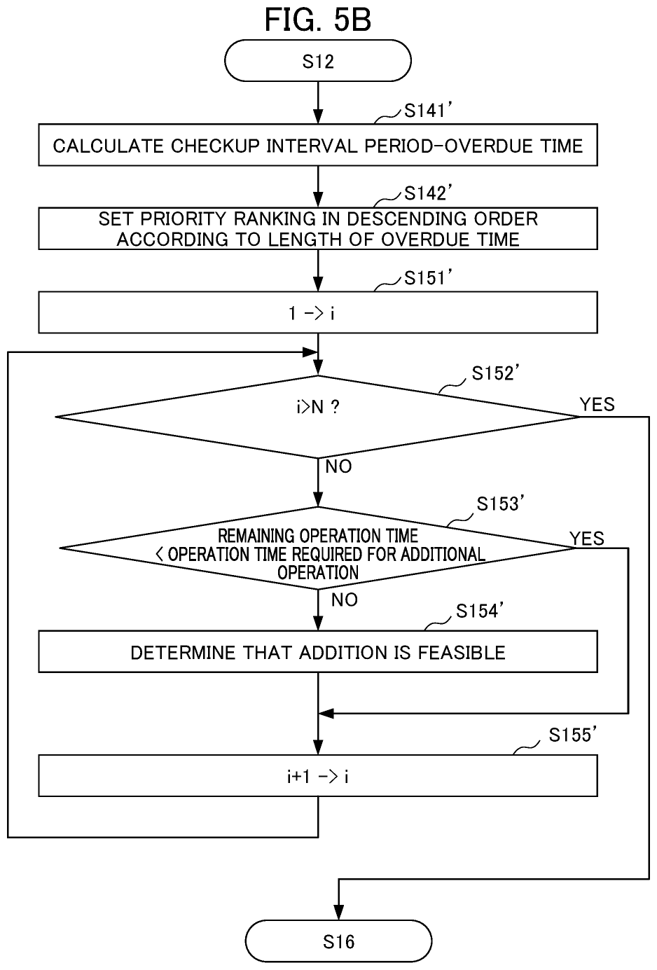

FIGS. 4, 5A, and 5B are each a flowchart showing processing to be carried out by the maintenance scheduling device 1 for formulating an optimized maintenance schedule. The processing flow described below shows maintenance schedule formulation processing to be carried out in a case where maintenance is performed on robots 2a installed in an area assigned to a group of maintenance engineers. It should be noted that FIG. 4 is a diagram showing an overview of the processing flow. The detailed flows of processes in Steps S14 and S15 shown in FIG. 4 are described below based on the flowcharts shown in FIGS. 5A and 5B.

Referring to the flowchart shown in FIG. 4, in Step S10, the maintenance scheduling device 1 (mandatory maintenance operation information acquisition unit 101) acquires a maintenance date, an overall operation time set for the maintenance, an identification number of a robot 2a subject to a maintenance operation for mandatory maintenance items, the mandatory maintenance items, and an operation time required for the maintenance for the mandatory maintenance items.

In Step S11, the maintenance scheduling device 1 (mandatory maintenance operation information acquisition unit 101) acquires a maintenance time required for the mandatory maintenance items by calculating the total operation time required for the maintenance for the mandatory maintenance items.

In Step S12, the maintenance scheduling device 1 (maintenance operation information acquisition unit 102) acquires maintenance operation information including identification numbers of any robots 2a that are each expected to exceed the checkup interval period, checkup items related to each of such robots 2a, and an operation time required for each of additional operations necessary for the checkup items.

In Step S13, the maintenance scheduling device 1 (addition feasibility determination unit 106) calculates a remaining operation time by subtracting the maintenance time required for the mandatory maintenance items from the overall operation time set for the maintenance.

In Step S14, the maintenance scheduling device 1 (addition feasibility determination unit 106) sets a priority ranking based on the checkup interval period-overdue time of each of the robots 2a that have exceeded the checkup interval period.

In Step S15, the maintenance scheduling device 1 (addition feasibility determination unit 106) determines, in the order of the priority ranking, whether or not each of additional operations necessary for the checkup items related to the robots 2a that have exceeded the checkup interval period is executable.

In Step S16, the maintenance scheduling device 1 (addition feasibility determination unit 106) acquires information on the additional operations necessary for the checkup items related to all robots 2a that have exceeded the checkup interval period and for which the maintenance scheduling device 1 has determined in Step S15 that the additional operation necessary for the checkup items is executable within the remaining operation time.

In Step S17, the maintenance scheduling device 1 (maintenance schedule formulation unit 107) formulates a maintenance schedule that includes the additional operations in addition to the maintenance for the mandatory maintenance items.

In Step S18, the maintenance scheduling device 1 (maintenance schedule formulation unit 107) provides the thus formulated maintenance schedule to the system/facility manager through the display unit 50. An overview of the processing flow in the maintenance scheduling device 1 has been described above. The following describes detailed flows of processes in Steps S14 and S15 mentioned above. FIGS. 5A and 5B show examples of flows of processes for determining whether or not each additional operation is executable based on the priority ranking. Specifically, the flow of processes shown in FIG. 5A represents an example of the aforementioned first determination form. The flow of processes shown in FIG. 5B represents an example of the aforementioned second determination form.

Referring to FIG. 5A, in Step S141, the maintenance scheduling device 1 (addition feasibility determination unit 106) calculates the checkup interval period-overdue time for each of the robots 2a expected to exceed the checkup interval period and acquired in Step S12.

In Step S142, the maintenance scheduling device 1 (addition feasibility determination unit 106) sets the priority ranking of the robots 2a in descending order according to the length of checkup interval period-overdue time. Hereinafter, the number of robots 2a expected to exceed the checkup interval period is represented by N (an integer equal to or greater than 1), and the robots 2a are distinguished from each other according to the priority ranking. Specifically, a robot 2a having the i-th priority is referred to as a robot 2a(i).

In Step S151, i is initialized (1->i) and the value of the remaining operation time is set to the value calculated in Step S13 by subtracting the maintenance time required for the mandatory maintenance items from the overall operation time set for the maintenance.

In Step S152, the maintenance scheduling device 1 determines whether or not i is greater than N. If i is greater than N, the processing continues to Step S16. If i is not greater than N, the processing continues to Step S153.

In Step S153, the maintenance scheduling device 1 determines whether or not the value of the remaining operation time is equal to or greater than the operation time required for the additional operation necessary for the checkup items related to the robot 2a(i). If the value of the remaining operation time is equal to or greater than the operation time required for the additional operation necessary for the checkup items related to the robot 2a(i) (if Yes), the processing continues to Step S154. If the value of the remaining operation time is less than the operation time required for the additional operation necessary for the checkup items related to the robot 2a(i) (if No), the processing continues to Step S16.

In Step S154, the maintenance scheduling device 1 adds the additional operation necessary for the checkup items related to the robot 2a(i) to the maintenance schedule and subtracts the operation time required for the additional operation necessary for the checkup items related to the robot 2a(i) from the value of the remaining operation time.

In Step S155, the maintenance scheduling device 1 adds 1 to i (i+1->i), and the processing returns to Step S152. Through the processes described above, the first determination form can be carried out, whereby the maintenance scheduling device 1 makes the determination in the order of the priority ranking, and once the additional operation is determined to be not executable for a robot 2a, determines that the additional operation is not executable for all other of the robots 2a having a lower priority. The flow of processes according to the aforementioned first determination form has been described above. Next, the flow of processes according to the aforementioned second determination form will be described.

Referring to FIG. 5B, processes to be performed in Steps S141′ to S152′ are equivalent to those in Steps S141 to S152 shown in FIG. 5A.

In Step S153′, the maintenance scheduling device 1 determines whether or not the value of the remaining operation time is equal to or greater than the operation time required for the additional operation necessary for the checkup items related to the robot 2a(i). If the value of the remaining operation time is equal to or greater than the operation time required for the additional operation necessary for the checkup items related to the robot 2a(i) (if Yes), the processing continues to Step S154′. If the value of the remaining operation time is less than the operation time required for the additional operation necessary for the checkup items related to the robot 2a(i) (if No), the processing continues to Step S155′.

In Step S154′, the maintenance scheduling device 1 adds the additional operation necessary for the checkup items related to the robot 2a(i) to the maintenance schedule and subtracts the operation time required for the additional operation necessary for the checkup items related to the robot 2a(i) from the value of the remaining operation time.

In Step S155′, the maintenance scheduling device 1 adds 1 to i (i+1->i), and the processing returns to Step S152. Through the processes described above, the maintenance scheduling device 1 can make the determination in the order of the priority ranking, and upon determining that the additional operation is not executable for a robot 2a, determine whether or not the additional operation is executable for a robot 2a having the next highest priority. The flow of processes according to the aforementioned second determination form has been described above.

It should be noted that, as described above, the maintenance scheduling device 1 may set a priority ranking by giving preference to a robot 2a having a greater ratio of the checkup interval period-overdue time relative to the checkup interval period of the robot 2a. In this case, in Step S142 and Step S142′ in FIG. 5A and FIG. 5B, the maintenance scheduling device 1 (addition feasibility determination unit 106) can perform the process for setting the priority ranking of robots 2a in descending order according to the ratio of the checkup interval period-overdue time of each robot 2a relative to the checkup interval period of the robot 2a instead of the process for setting the priority ranking of robots 2a in descending order according to the length of checkup interval period-overdue time. The flow of processing for the maintenance scheduling device 1 to formulate an optimized maintenance schedule has been described above.

To put the foregoing into other words, the maintenance scheduling device and the maintenance scheduling method according to the present disclosure can take various embodiments having the following configurations.

(1) A maintenance scheduling device (for example, “maintenance scheduling device 1”) according to the present embodiment includes:
a mandatory maintenance operation information acquisition unit (for example, “mandatory maintenance operation information acquisition unit 101”) configured to acquire mandatory maintenance items related to an industrial machine, a maintenance date on which maintenance for the mandatory maintenance items is performed, and an operation time required for the maintenance for the mandatory maintenance items; a maintenance operation information acquisition unit (for example, “maintenance operation information acquisition unit 102”) configured to acquire maintenance operation information including at least checkup items related to industrial machines including a robot that are each expected to exceed a checkup interval period before or on the maintenance date and an operation time required for each of additional operations necessary for the checkup items;
an addition feasibility determination unit (for example, “addition feasibility determination unit 106”) configured to determine whether or not each of the additional operations is executable within a remaining operation time calculated by subtracting the operation time required for the maintenance for the mandatory maintenance items from an overall operation time set for the maintenance date; and
a maintenance schedule formulation unit (for example, “maintenance schedule formulation unit 107”) configured to formulate a maintenance schedule that includes, in addition to the maintenance, every additional operation determined to be executable by the addition feasibility determination unit (for example, “addition feasibility determination unit 106”) out of the additional operations. This configuration makes it possible to, when maintenance for mandatory maintenance items is scheduled to be performed on a machine among machines such as robots, machine tools, and peripheral equipment, formulate an optimized maintenance schedule by automatically scheduling a periodic component replacement operation and a checkup operation for another machine on a scheduled maintenance date (shutdown date) in addition to the maintenance on the machine for the mandatory maintenance items.

(2) In the maintenance scheduling device (for example, “maintenance scheduling device 1”) described in (1),
the maintenance operation information acquisition unit (for example, “maintenance operation information acquisition unit 102”) may be further configured to acquire a checkup interval period-overdue time of each of the industrial machines including a robot that have exceeded the checkup interval period, the checkup interval period-overdue time being a duration of time elapsed after the checkup interval period has passed,
the addition feasibility determination unit (for example, “addition feasibility determination unit 106”) may be further configured to
set a priority ranking based on the checkup interval period-overdue time of each of the industrial machines acquired by the maintenance operation information acquisition unit (for example, “maintenance operation information acquisition unit 102”),
determine, for each of the additional operations necessary for checkup acquired by the maintenance operation information acquisition unit (for example, “maintenance operation information acquisition unit 102”) and in the order of the priority ranking, whether or not the additional operation necessary for checkup is executable within the remaining operation time calculated by subtracting the operation time required for the maintenance for the mandatory maintenance items from the overall operation time, and
upon determining that an additional operation is executable, continue the determination using an updated remaining operation time calculated by subtracting the operation time required for the additional operation necessary for checkup determined to be executable from the previously calculated remaining operation time, and
the maintenance schedule formulation unit (for example, “maintenance schedule formulation unit 107”) may be further configured to formulate a maintenance schedule that includes, in addition to the maintenance, every additional operation necessary for checkup determined to be executable out of the additional operations, once any of the additional operations necessary for checkup is determined to be not executable by the addition feasibility determination unit (for example, “addition feasibility determination unit 106”). This configuration makes it possible to formulate a maintenance schedule by giving preference to a checkup operation having a higher priority.

(3) In the maintenance scheduling device (for example, “maintenance scheduling device 1”) described in (1),
the maintenance operation information acquisition unit (for example, “maintenance operation information acquisition unit 102”) may be further configured to acquire a checkup interval period-overdue time of each of the industrial machines including a robot that have exceeded the checkup interval period, the checkup interval period-overdue time being a duration of time elapsed after the checkup interval period has passed,
the addition feasibility determination unit (for example, “addition feasibility determination unit 106”) may be further configured to
set a priority ranking based on the checkup interval period-overdue time of each of the industrial machines acquired by the maintenance operation information acquisition unit, determine, for each of the additional operations necessary for checkup acquired by the maintenance operation information acquisition unit and in the order of the priority ranking, whether or not the additional operation necessary for checkup is executable within the remaining operation time calculated by subtracting the operation time required for the maintenance for the mandatory maintenance items from the overall operation time,
upon determining that an additional operation is executable, continue the determination using an updated remaining operation time calculated by subtracting the operation time required for the additional operation necessary for checkup determined to be executable from the previously calculated remaining operation time, and
upon determining that an additional operation is not executable, continue to determine whether or not the additional operation necessary for checkup having the next highest priority is executable within the updated remaining operation time, and
the maintenance schedule formulation unit (for example, “maintenance schedule formulation unit 107”) may be further configured to formulate a maintenance schedule that includes, in addition to the maintenance, every additional operation necessary for checkup determined to be executable out of the additional operations, once all the additional operations necessary for checkup have been determined to be executable or not executable by the addition feasibility determination unit. This configuration makes it possible to formulate an efficient maintenance schedule preferentially including a checkup operation having a higher priority and additionally including a checkup operation that requires a shorter additional operation time for checkup.

(4) In the maintenance scheduling device (for example, “maintenance scheduling device 1”) described in (2) or (3), the priority ranking may give preference to an industrial machine having a longer checkup interval period-overdue time out of the industrial machines acquired by the maintenance operation information acquisition unit (for example, “maintenance operation information acquisition unit 102”). This configuration makes it possible to formulae a maintenance schedule by giving preference to maintenance or checkup of a robot 2a that has significantly exceeded its checkup interval period.

(5) In the maintenance scheduling device (for example, “maintenance scheduling device 1”) described in (2) or (3), the priority ranking may give preference to an industrial machine having a greater ratio of the checkup interval period-overdue time relative to the corresponding checkup interval period out of the industrial machines acquired by the maintenance operation information acquisition unit (for example, “maintenance operation information acquisition unit 102”). This configuration makes it possible to make a relative comparison between the overdue time of a robot 2a having a longer checkup interval period and the overdue time of a robot 2a having a shorter checkup interval period based on the ratio of the checkup interval period-overdue time of each robot 2a to the checkup interval period thereof. If the overdue time of a robot 2a having a longer checkup interval period and the overdue time of a robot 2a having a shorter checkup interval period are approximately the same, the determination may be made by giving preference to the robot 2a having the shorter checkup interval period.

(6) In the maintenance scheduling device (for example, “maintenance scheduling device 1”) described in any one of (1) to (5),
the overall operation time for the maintenance date and the operation time required for each additional operation necessary for the checkup items are set depending on the number of maintenance engineers who work simultaneously. This configuration makes it possible to appropriately set the overall operation time for the maintenance date and the operation time required for each additional operation necessary for the checkup items depending on whether there are a large number of maintenance engineers or a small number of maintenance engineers.

(7) A maintenance scheduling method according to the present embodiment includes implementation by a computer of: a mandatory maintenance operation information acquisition step for acquiring mandatory maintenance items related to an industrial machine, a maintenance date on which maintenance for the mandatory maintenance items is performed, and an operation time required for the maintenance for the mandatory maintenance items;
a maintenance operation information acquisition step for acquiring maintenance operation information including at least checkup items related to industrial machines including a robot that are each expected to exceed a checkup interval period before or on the maintenance date and an operation time required for each of additional operations necessary for the checkup items;
an addition feasibility determination step for determining whether or not each of the additional operations is executable within a remaining operation time calculated by subtracting the operation time required for the maintenance for the mandatory maintenance items from an overall operation time set for the maintenance date; and
a maintenance schedule formulation step for formulating a maintenance schedule that includes, in addition to the maintenance, every additional operation determined to be executable in the addition feasibility determination step out of the additional operations. This configuration makes it possible to produce the same effects as in the maintenance scheduling device described in (1).

(8) In the maintenance scheduling method described in (7),
the maintenance operation information acquisition step may further include acquiring a checkup interval period-overdue time of each of the industrial machines including a robot that have exceeded the checkup interval period, the checkup interval period-overdue time being a duration of time elapsed after the checkup interval period has passed,
the addition feasibility determination step may further include
setting a priority ranking based on the checkup interval period-overdue time of each of the industrial machines acquired in the maintenance operation information acquisition step,
determining, for each of the additional operations necessary for checkup acquired in the maintenance operation information acquisition step and in the order of the priority ranking, whether or not the additional operation necessary for checkup is executable within the remaining operation time calculated by subtracting the operation time required for the maintenance for the mandatory maintenance items from the overall operation time, and
upon determining that an additional operation is executable, continuing the determination using an updated remaining operation time calculated by subtracting the operation time required for the additional operation necessary for checkup determined to be executable from the previously calculated remaining operation time, and
the maintenance schedule formulation step may further include formulating a maintenance schedule that includes, in addition to the maintenance, every additional operation necessary for checkup determined to be executable out of the additional operations, once any of the additional operations necessary for checkup is determined to be not executable in the addition feasibility determination step. This configuration makes it possible to produce the same effects as in the maintenance scheduling device described in (2).

(9) In the maintenance scheduling method described in (7),
the maintenance operation information acquisition step may further include acquiring a checkup interval period-overdue time of each of the industrial machines including a robot that have exceeded the checkup interval period, the checkup interval period-overdue time being a duration of time elapsed after the checkup interval period has passed,
the addition feasibility determination step may further include
setting a priority ranking based on the checkup interval period-overdue time of each of the industrial machines acquired in the maintenance operation information acquisition step,
determining, for each of the additional operations necessary for checkup acquired in the maintenance operation information acquisition step and in the order of the priority ranking, whether or not the additional operation necessary for checkup is executable within the remaining operation time calculated by subtracting the operation time required for the maintenance for the mandatory maintenance items from the overall operation time,
upon determining that an additional operation is executable, continuing the determination using an updated remaining operation time calculated by subtracting the operation time required for the additional operation necessary for checkup determined to be executable from the previously calculated remaining operation time, and
upon determining that an additional operation is not executable, continuing to determine whether or not the additional operation necessary for checkup having the next highest priority is executable within the updated remaining operation time, and
the maintenance schedule formulation step may further include formulating a maintenance schedule that includes, in addition to the maintenance, every additional operation necessary for checkup determined to be executable out of the additional operations, once all the additional operations necessary for checkup have been determined to be executable or not executable in the addition feasibility determination step. This configuration makes it possible to produce the same effects as in the maintenance scheduling device described in (3).

While an embodiment of the present invention has been described above, the present invention is not limited to the foregoing embodiment. The aforementioned effects of the foregoing embodiment are merely a list of the most preferable effects resulting from the present invention. Effects that are produced by the present invention are not limited to the aforementioned effects of the foregoing embodiment.

### EXPLANATION OF REFERENCE NUMERALS

100: Production system
1: Maintenance scheduling device
10: Control unit
101: Mandatory maintenance operation information acquisition unit
102: Maintenance operation information acquisition unit
106: Addition feasibility determination unit
107: Maintenance schedule formulation unit
20: Storage unit
30: Communication unit
50: Display unit
60: Input unit
2: Industrial machine
2a: Robot
2b: Machine tool
2c: Peripheral equipment
3: Machine control device
30: Control unit
301: Operating information acquisition unit
302: Checkup interval period-overdue time calculation unit
303: Maintenance information transmission unit
32: Storage unit
4: Cell control device
6: Communication network

1. A maintenance scheduling device comprising:
a mandatory maintenance operation information acquisition unit configured to acquire mandatory maintenance items related to an industrial machine, a maintenance date on which maintenance for the mandatory maintenance items is performed, and an operation time required for the maintenance for the mandatory maintenance items;
a maintenance operation information acquisition unit configured to acquire maintenance operation information including at least checkup items related to industrial machines including a robot that are each expected to exceed a checkup interval period before or on the maintenance date and an operation time required for each of additional operations necessary for the checkup items;
an addition feasibility determination unit configured to determine whether or not each of the additional operations is executable within a remaining operation time calculated by subtracting the operation time required for the maintenance for the mandatory maintenance items from an overall operation time set for the maintenance date; and
a maintenance schedule formulation unit configured to formulate a maintenance schedule that includes, in addition to the maintenance, every additional operation determined to be executable by the addition feasibility determination unit out of the additional operations.

2. The maintenance scheduling device according to claim 1, wherein
the maintenance operation information acquisition unit is further configured to acquire a checkup interval period-overdue time of each of the industrial machines including a robot that have exceeded the checkup interval period, the checkup interval period-overdue time being a duration of time elapsed after the checkup interval period has passed,
the addition feasibility determination unit is further configured to
set a priority ranking based on the checkup interval period-overdue time of each of the industrial machines acquired by the maintenance operation information acquisition unit,
determine, for each of the additional operations necessary for checkup acquired by the maintenance operation information acquisition unit and in the order of the priority ranking, whether or not the additional operation necessary for checkup is executable within the remaining operation time calculated by subtracting the operation time required for the maintenance for the mandatory maintenance items from the overall operation time, and
upon determining that an additional operation is executable, continue the determination using an updated remaining operation time calculated by subtracting the operation time required for the additional operation necessary for checkup determined to be executable from the previously calculated remaining operation time, and
the maintenance schedule formulation unit is further configured to formulate a maintenance schedule that includes, in addition to the maintenance, every additional operation necessary for checkup determined to be executable out of the additional operations, once any of the additional operations necessary for checkup is determined to be not executable by the addition feasibility determination unit.

3. The maintenance scheduling device according to claim 1, wherein
the maintenance operation information acquisition unit is further configured to acquire a checkup interval period-overdue time of each of the industrial machines including a robot that have exceeded the checkup interval period, the checkup interval period-overdue time being a duration of time elapsed after the checkup interval period has passed,
the addition feasibility determination unit is further configured to
set a priority ranking based on the checkup interval period-overdue time of each of the industrial machines acquired by the maintenance operation information acquisition unit,
determine, for each of the additional operations necessary for checkup acquired by the maintenance operation information acquisition unit and in the order of the priority ranking, whether or not the additional operation necessary for checkup is executable within the remaining operation time calculated by subtracting the operation time required for the maintenance for the mandatory maintenance items from the overall operation time,
upon determining that an additional operation is executable, continue the determination using an updated remaining operation time calculated by subtracting the operation time required for the additional operation necessary for checkup determined to be executable from the previously calculated remaining operation time, and
upon determining that an additional operation is not executable, continue to determine whether or not the additional operation necessary for checkup having the next highest priority is executable within the updated remaining operation time, and
the maintenance schedule formulation unit is further configured to formulate a maintenance schedule that includes, in addition to the maintenance, every additional operation necessary for checkup determined to be executable out of the additional operations, once all the additional operations necessary for checkup have been determined to be executable or not executable by the addition feasibility determination unit.

4. The maintenance scheduling device according to claim 2, wherein
the priority ranking gives preference to an industrial machine having a longer checkup interval period-overdue time out of the industrial machines acquired by the maintenance operation information acquisition unit.

5. The maintenance scheduling device according to claim 2, wherein
the priority ranking gives preference to an industrial machine having a greater ratio of the checkup interval period-overdue time relative to the corresponding checkup interval period out of the industrial machines acquired by the maintenance operation information acquisition unit.

6. The maintenance scheduling device according to claim 1, wherein the overall operation time for the maintenance date and the operation time required for each additional operation necessary for the checkup items are set depending on the number of maintenance engineers who work simultaneously.

7. A maintenance scheduling method for formulating a maintenance schedule of industrial machines including a robot, the maintenance scheduling method comprising implementation by a computer of:
a mandatory maintenance operation information acquisition step for acquiring mandatory maintenance items related to one of the industrial machines, a maintenance date on which maintenance for the mandatory maintenance items is performed, and an operation time required for the maintenance for the mandatory maintenance items;
a maintenance operation information acquisition step for acquiring maintenance operation information including at least checkup items related to industrial machines including a robot that are each expected to exceed a checkup interval period before or on the maintenance date and an operation time required for each of additional operations necessary for the checkup items;
an addition feasibility determination step for determining whether or not each of the additional operations is executable within a remaining operation time calculated by subtracting the operation time required for the maintenance for the mandatory maintenance items from an overall operation time set for the maintenance date; and
a maintenance schedule formulation step for formulating a maintenance schedule that includes, in addition to the maintenance, every additional operation determined to be executable in the addition feasibility determination step out of the additional operations.

8. The maintenance scheduling method according to claim 7, wherein
the maintenance operation information acquisition step further includes acquiring a checkup interval period-overdue time of each of the industrial machines including a robot that have exceeded the checkup interval period, the checkup interval period-overdue time being a duration of time elapsed after the checkup interval period has passed,
the addition feasibility determination step further includes
setting a priority ranking based on the checkup interval period-overdue time of each of the industrial machines acquired in the maintenance operation information acquisition step,
determining, for each of the additional operations necessary for checkup acquired in the maintenance operation information acquisition step and in the order of the priority ranking, whether or not the additional operation necessary for checkup is executable within the remaining operation time calculated by subtracting the operation time required for the maintenance for the mandatory maintenance items from the overall operation time, and
upon determining that an additional operation is executable, continuing the determination using an updated remaining operation time calculated by subtracting the operation time required for the additional operation necessary for checkup determined to be executable from the previously calculated remaining operation time, and
the maintenance schedule formulation step further includes formulating a maintenance schedule that includes, in addition to the maintenance, every additional operation necessary for checkup determined to be executable out of the additional operations, once any of the additional operations necessary for checkup is determined to be not executable in the addition feasibility determination step.

9. The maintenance scheduling method according to claim 7, wherein
the maintenance operation information acquisition step further includes acquiring a checkup interval period-overdue time of each of the industrial machines including a robot that have exceeded the checkup interval period, the checkup interval period-overdue time being a duration of time elapsed after the checkup interval period has passed,
the addition feasibility determination step further includes
setting a priority ranking based on the checkup interval period-overdue time of each of the industrial machines acquired in the maintenance operation information acquisition step,
determining, for each of the additional operations necessary for checkup acquired in the maintenance operation information acquisition step and in the order of the priority ranking, whether or not the additional operation necessary for checkup is executable within the remaining operation time calculated by subtracting the operation time required for the maintenance for the mandatory maintenance items from the overall operation time,
upon determining that an additional operation is executable, continuing the determination using an updated remaining operation time calculated by subtracting the operation time required for the additional operation necessary for checkup determined to be executable from the previously calculated remaining operation time, and
upon determining that an additional operation is not executable, continuing to determine whether or not the additional operation necessary for checkup having the next highest priority is executable within the updated remaining operation time, and
the maintenance schedule formulation step further includes formulating a maintenance schedule that includes, in addition to the maintenance, every additional operation necessary for checkup determined to be executable out of the additional operations, once all the additional operations necessary for checkup have been determined to be executable or not executable in the addition feasibility determination step.
